(19) United States
(12) Patent Application Publication
(10) Pub. No.: US 2026/0348714 A1
(43) Pub. Date: Nov. 5, 2026

(54) SENSOR FOR MEASURING A DISTANCE OR A POSTION

(71) Applicant: MICRO-EPSILON-MESSTECHNIK GMBH & CO. K.G., Ortenburg (DE)

(72) Inventors: Benedikt BILLER, Deggendorf (DE); Julian KASBERGER, Ruhstorf an der Rott (DE); Norbert REINDL, Furstenzell (DE); Thomas WISSPEINTNER, Ortenburg (DE)

(21) Appl. No.: 19/125,620

(22) PCT Filed: Oct. 4, 2023
(86) PCT No.: PCT/DE2023/200207

§ 371 Date: Apr. 29, 2025

(30) Foreign Application Priority Data
Nov. 9, 2022 (DE) 10 2022 211 847.2

(51) Int. Cl. G01B 7/14; G01B 7/00

(52) U.S. Cl. CPC G01B 7/14; G01B 7/003

(57) ABSTRACT

The aim of the invention is to provide a reliable measuring behavior in a wide variety of environmental conditions using structurally simple means. This is achieved in that a sensor for measuring a distance or a position, in particular a sensor which operates in a capacitive or inductive manner or on the basis of an eddy current, comprising a support (10; 20) which has a flat region (2) and comprising a sensor element (5a, 5b) which is arranged on the flat region (2) or which is integrated into the flat region (2), is designed and developed such that the support (10; 20), the flat region (2), or the sensor element (5a, 5b) is paired with a device (3) for conducting a gaseous medium along the flat region (2) or the sensor element (5a, 5b).

### CROSS REFERENCE TO RELATED APPLICATIONS

This application is a National Stage Application, filed under 35 U.S.C. § 371, of International Application No. PCT/DE2023/200207, filed Oct. 4, 2023, which international application claims priority to and the benefit of German Application No. 10 2022 211 847.2, filed Nov. 9, 2022; the contents of both of which as are hereby incorporated by reference in their entireties.

### BACKGROUND

### Technical Field

The invention relates to a sensor for measuring a distance or a position, in particular a sensor that operates capacitively or inductively or on the basis of an eddy current, comprising a carrier, which has a planar region, and a sensor element, which is arranged on the planar region or integrated into the planar region.

### Description of Related Art

For the measurement of roll gaps, for example, high-resolution capacitive sensors may be used very successfully. For this purpose, flat sensors that measure on one side or two sides are used, which can for example measure gaps above 0.5 mm between two rolls. The measurement is not limited to rolls but may be used both for flat and curved surfaces.

Depending on the place of use, a large buildup of particles may occur during these measurements, more particularly when the sensors are mounted horizontally and it is easy for particles or dust to remain lying on the sensor face.

Too many particles on the sensors may interfere with the distance measurement. A capacitive sensor reacts not only to the distance actually to be measured, but also to the medium in the gap. This means that an electrically nonconductive medium in the gap increases the capacitance, which in the evaluation of the sensor signal is equivalent to a distance reduction. An increasing accumulation of particles cannot therefore be distinguished from a slow distance change.

Especially in the case of conductive dust, however, for example graphite or carbon fibers, short-circuits and complete failures of the capacitive gap measurement also occur besides the variation in the dielectricity.

According to the current prior art, in some cases a separate air exit nozzle is mounted in the vicinity of the sensor in gap sensors, although this generates a turbulent flow in the region of the sensor. A turbulent flow generated in such a way with corresponding air vortices may lead to thin and/or flexible sensors bending or being excited in oscillation. This leads to unusable measurements.

Insofar as is possible, various protective plates or other mechanical precautions may be mounted in dusty environments. These offer mechanical protection against fouling, or at least a reduction of fouling, but also entail increased requirements for the necessary installation space.

If the respective installation situations so allow, optical sensors that are built into protective housings are also used for such applications. These protective housings sometimes also have air connectors, for example in order to keep an optical window for a sensor element free. However, these protective housings significantly restrict the installation possibilities because of their respective extent.

### BRIEF SUMMARY

The object of the present invention is therefore to provide a sensor of the type mentioned in the introduction, which allows a reliable measurement response with simply designed means under a very wide variety of ambient conditions.

According to the invention, the above object is achieved by a sensor having the features of claim 1. Accordingly, the sensor is configured and developed in such a way that a device for creating a flow of a gaseous medium along the planar region or sensor element is allocated to the carrier, the planar region or the sensor element.

According to the invention, it has firstly been discovered that the above object is achieved in a surprisingly straightforward way by expedient production of a device for the elimination or reduction of fouling or particles that accumulate on the planar region or the sensor element. Further, according to the invention, it has been discovered that the device may be allocated to the carrier, the planar region or sensor element specifically in such a way that a flow of a gaseous medium along the planar region or sensor element is provided. Such a flow along the planar region or sensor element ensures on the one hand effective elimination or reduction of fouling or particles that accumulate on the planar region or the sensor element, and on the other hand minimal mechanical strain of the sensor element by bending of the sensor element due to turbulent air vortices. The planar region or the sensor element may therefore be rid of fouling or particles very gently by means of the gaseous medium. Interference with the measurement response may in this case be very substantially avoided and the sensor delivers reliable measurement results even in environments in which fouling and particles occur.

The sensor according to the invention therefore provides a sensor which allows a reliable measurement response with simply designed means under a very wide variety of ambient conditions. With a view to particularly gentle elimination of fouling or particles on the planar region or sensor element, the device may be configured to generate a laminar flow of the medium along the planar region or sensor element. Such a laminar flow is distinguished by its consistent flow rate, which does not exert any abrupt impulses on a sensor element or a planar region, as may be the case for example with turbulent air vortices. Furthermore, a laminar flow inherently prevents adhesion of fouling and particles on the planar region or sensor element. Fouling and particles comprise inter alia dust and liquids such as water and oils. In any event, a steady flow is advantageous in order not to generate any transverse forces or bending moments on the planar region or the sensor element, which may in turn lead to vibrations of a thin carrier or sensor element. Furthermore, the trajectory of fouling and particles can be controlled well by a laminar flow.

In order to ensure particularly effective elimination of particles or other fouling, the device may have an adjustment mechanism or regulating mechanism for adjusting or regulating the flow and/or a flow rate of the medium. A constant flow with a constant flow rate may in this case be adjusted and/or be regulated, for example by using suitable measurement sensors. Furthermore, if fouling is already present, the adjustment device may generate a pressure surge or a pulsed flow in order to remove fouling that may for example result from failure of the supply of the medium or compressed air, which may lead to accumulations that can remain adhering more or less strongly on a planar region or a sensor element depending on the material, in the event of a sudden high occurrence of fouling or during prolonged stagnation. Flow may in this case take place initially with a relatively high pressure or relatively high Reynolds number, and a pressure may subsequently be reduced, preferably as far as a desired flow or flow rate.

In one specific exemplary embodiment, the flow of the medium may be guided transversely with respect to a measurement direction. This ensures that fouling or particles are purposely moved out from a measurement line predefined by the measurement direction. Alternatively or in addition thereto, the flow of the medium may be guided parallel to the planar region or sensor element. This ensures reliable guiding of fouling or particles away from the planar region or sensor element, without for example bending moments by which a measurement would be vitiated, or rendered impossible, being exerted on the planar region or the sensor element.

In respect of particularly reliable operation of the sensor, the device may comprise a guide element for the flow of the medium, which is allocated to the carrier, the planar region or the sensor element and/or can be coupled to the carrier, to the planar region or to the sensor element and can be uncoupled from the carrier, the planar region or the sensor element. Such a guide element allows a particularly reliable guiding of a flow of the gaseous medium. Depending on the configuration of the guide element, the medium may be conveyed by the guide element in different desired directions in order to eliminate fouling or particles on the planar region or sensor element. By the possibility of coupling and uncoupling, the sensor may also be operated without such a guide element according to requirements. This offers high flexibility in respect of the use of a sensor, on the one hand with and on the other hand without a guide element. It is also thereby possible to retrofit a sensor with a guide element.

With a view to particularly reliable generation of the flow and therefore reliable operation of the sensor, the guide element may comprise a connector for a supply line for the medium. The medium is in this case guided in a straightforward and reliably controllable way through or by the guide element to the planar region or sensor element.

Furthermore, in respect of particularly reliably controlled generation of the flow, the guide element may comprise a reception or distribution chamber for the medium, which is in fluid communication with the connector. Such a reception or distribution chamber may serve as a buffer chamber for the medium and convey received medium in a controlled way to the planar region or sensor element.

For reliable guiding of the flow to the planar region or sensor element, the reception or distribution chamber may comprise at least one outlet for the medium. When one outlet is formed, all of the medium received in the reception or distribution chamber may purposely be conveyed along the planar region or sensor element. When two or more outlets are formed, a plurality of planar regions or sensor elements of the sensor may be supplied with the medium in order to allow the medium received in the reception or distribution chamber to flow along a plurality of planar regions or sensor elements. In the case of a gap sensor comprising two sensor elements, which measure in opposite directions, the medium may be conveyed simultaneously along both sensor elements or along the two associated planar regions in order to achieve the elimination of fouling or particles. By the parallel flows thereby generated, the sensor elements are so to speak sandwiched by the two flows so that the generation of bending moments on the sensor elements, which are detrimental to a measurement, is particularly reliably avoided.

According to requirements and depending on the configuration of the planar region or sensor element, the at least one outlet may comprise a slit, a slit with at least one guide strip or a plurality of apertures arranged next to one another. When a slit is formed—with or without a guide strip—a wide, thin and flat flow may be produced. A flat flow may also be produced reliably by a plurality of apertures arranged next to one another.

The guide element may be formed either in one piece or in multiple pieces. If it is formed in multiple pieces, the guide element may be adapted individually to different measurement conditions, for example of a geometrical nature. Forming it in multiple pieces also allows straightforward replacement of damaged parts while reusing undamaged parts.

In a further exemplary embodiment, the guide element may comprise two couplable or screwable half-shells or be constructed from two couplable or screwable half-shells. Such half-shells may for example be allocated to a carrier or sensor from different sides and very straightforwardly.

The carrier may in this case be arranged securely at least in regions between the half-shells and/or the half-shells may be fixed to the carrier by a clamping action, which provides an arrangement of the carrier that is protected particularly well by means of the half-shells as well as particularly reliable and stable coupling of the carrier and the half-shells or guide element.

Depending on the desired flow direction, the carrier and/or the guide element and/or the reception or distribution chamber may have a curved or angled shape. For example, the curved or angled shape may have a curvature or angles of about 90° in order to deflect the flow correspondingly by about 90° from a supply direction.

In one specific embodiment, the carrier or planar region may comprise two sensor elements, which measure in opposite directions, so as to form a gap sensor with which gap widths can be measured particularly straightforwardly. Very generally, the carrier or flat region may comprise a plurality of sensor elements which measure in different directions, in which case the number of sensor elements and directions may also be three or more, depending on the application.

With a view to a particularly straightforward and reliable design, the carrier may be configured as a printed circuit board or comprise a printed circuit board. The use of printed circuit boards as carriers has proven useful in practice, and allows flexible and economical production of the sensor.

With a view to particularly reliable driving and/or transmission of measurement data to evaluation electronics, the sensor element may be contacted with the evaluation electronics via a coaxial or triaxial cable. A particularly high shielding effect may be achieved by means of a triaxial cable.

Further advantages and aspects of exemplary embodiments of the sensor according to the invention are explained below:

By a permanently attached or retrospectively mountable guide element for the medium, it is possible to integrate a flow or air flow transversely with respect to the measurement direction, which blows away fouling or particles. The two half-shells described above may be configured so that an air flow is formed parallel to the sensor surface or the sensor element.

The flow may be produced over the entire sensor face or the entire sensor element, or entirely over the plurality of sensor elements, optionally on both sides of the carrier.

By a lateral connecting channel in the guide element, it is possible to produce an air chamber or reception or distribution chamber which is fed at one point—one connector—but allows outward flow at different openings or outlets. The direction from which the air or the medium is fed in is unimportant, and may be adapted individually according to the installation situation. For example, compressed air may be fed in through a connector.

This air guide, or this guide element, may be manufactured according to requirements from simple 3D-printed plastic parts up to more complex milled metal parts. The guide or the guide elements and the air chamber or the reception or distribution chamber may be formed as one unit.

In any event, a straightforward configuration of the air exit or of the outlet may be produced at the locations respectively required. In one simple case, the air exit or the outlet may comprise a slit nozzle with strips or without a strip in the gap for guiding the air—preferably in a laminar fashion.

The air exits or the outlets on both sides of the gap sensor have the advantage that the air flow or the flow of the medium does not cause a temperature change on one side and lead to a thin/flexible sensor being bent in one direction. This is because air or a medium is conveyed on both sides from the common air chamber or reception or distribution chamber. Even though deliberate cooling of the sensor does often take place by a temperature difference between the air or the medium and the sensor, this effect is the same on both sides and the sensor lying in the middle remains straight.

In particular, a slender configuration of the sensor in combination with a single connector or air connector allows a very compact sensor which may be employed very well even in narrow installation situations. The guide element may in this case be screwed over the sensor, which may still be mounted at its screwing points intended therefor.

The guide element may be adapted to a roll geometry and ensure additional mechanical stabilization of a thin sensor, for example having a thickness of 0.4 mm. This also reduces the tendency of the sensor to oscillate or vibrate, for example due to external vibrations. The guide element may have a curved surface.

Exemplary embodiments of the sensor according to invention may be used not only for measuring a roll gap, but also generally for gap measurements in a harsh environment where fouling may take place.

Very generally, the sensor, for example for a roll gap measurement, may be produced as a flat sensor having a device for creating a flow of a gaseous medium along the planar region or sensor element of the sensor. Very basically, the device for creating a flow of a gaseous medium may also be referred to as a blow off device, that is to say a device which blows fouling or particles off from the planar region or the sensor element.

### BRIEF DESCRIPTION OF THE FIGURES

There are now various possibilities for advantageously configuring and developing the teaching of the present invention. In this regard, reference may be made on the one hand to the dependent claims and on the other hand to the following explanation of preferred exemplary embodiments of the sensor according to invention. Generally preferred configurations and developments of the teaching are also explained in conjunction with the explanation of the preferred exemplary embodiments with the aid of the drawing. In the drawing,

FIG. 1 shows a perspective representation of a first exemplary embodiment of the sensor according to the invention,

FIG. 2 shows a partially sectional side view of the exemplary embodiment of FIG. 1 when used between two rolls,

FIG. 3 shows two exploded representations of the exemplary embodiment of FIG. 1, on the one hand from above and on the other hand obliquely from below,

FIG. 4 shows a partially sectional side view and a plan view of the exemplary embodiment of FIG. 1,

FIG. 5 shows an exploded representation, obliquely from above, of a second exemplary embodiment of the sensor according to the invention, and

FIG. 6 shows a side view and a plan view of the second exemplary embodiment of FIG. 5.

### DETAILED DESCRIPTION OF VARIOUS EMBODIMENTS

In the exemplary embodiments described below of the sensor according to the invention, which is configured as a gap sensor 1, reference signs that are the same denote identical components.

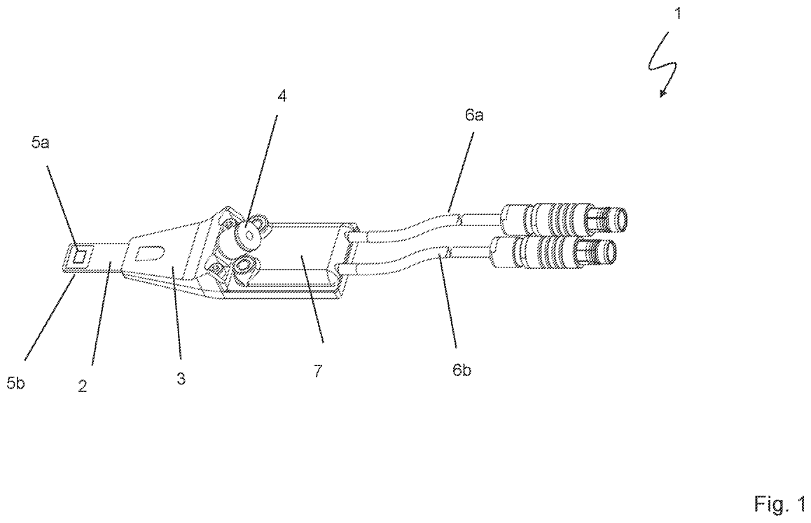

FIG. 1 shows a perspective representation of a first exemplary embodiment of the sensor according to the invention, which is configured as a gap sensor 1, comprising a substrate or carrier, which has a planar region 2, and a device 3 for creating a flow of a gaseous medium along the planar region 2, in which case the device 3 may also be referred to as a blow off device 3. The blow off device comprises a connector 4 for the gaseous medium-in this case air. Instead of air, other gaseous media may also be used for generating the flow. In this exemplary embodiment, the connector 4 is configured as a compressed-air connector 4, to which a pressure hose (not shown) can be connected. At the front end of the planar region 2, sensor elements 5a, 5b are arranged on opposite sides of the planar region 2 so that the sensor elements 5a, 5b measure in opposite directions, for example in order to determine a gap width. Compressed air can be applied to the gap sensor 1 through the connector 4 so that fouling or particles can be removed from the planar region 2 or from the sensor elements 5a, 5b by the flow of air.

The gap sensor 1 furthermore comprises two electrical connectors for the two capacitive sensor elements 5a, 5b, in the form of triaxial cables 6a, 6b which are contacted in a connector region 7 on the gap sensor 1.

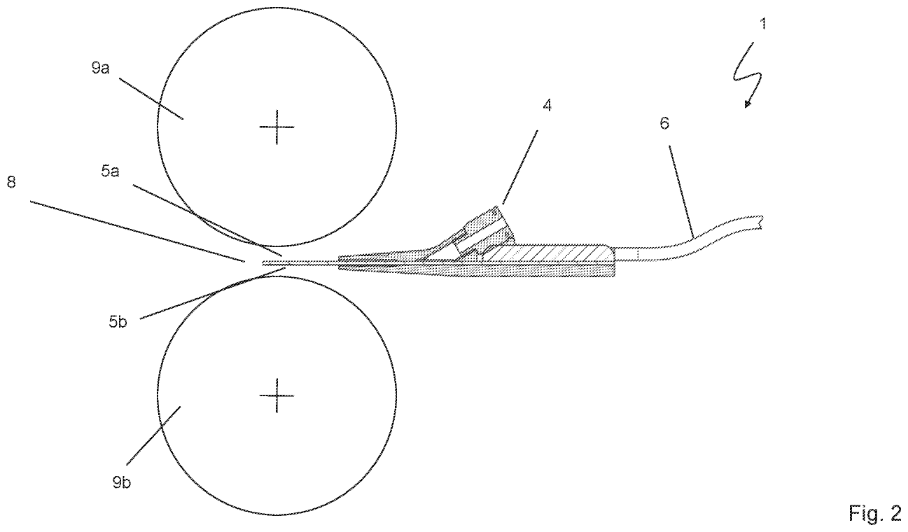

FIG. 2 shows a partially sectional view of the gap sensor 1 of FIG. 1 in an arrangement for measuring a roll gap 8 between two rolls 9a, 9b. The gap sensor 1 is in this case arranged laterally on the rolls 9a, 9b in a region through which the material to be rolled—not shown—does not pass. The planar region 2 protrudes with the sensor elements 5a, 5b into the roll gap 8. Alternatively, the gap sensor 1 may also be arranged in the region of the roll journal—not shown.

In order to avoid a collision of the pressure hose—not shown—with the rolls 9a, 9b, the compressed-air connector 4 and the triaxial cables 6 are arranged on the rearward side of the gap sensor 1.

With the aid of the sensor elements 5a, 5b, the roll gap 8 is measured by a first sensor element 5a that measures relative to the upper roll 9a and the second sensor element 5b that measures relative to the lower roll 9b.

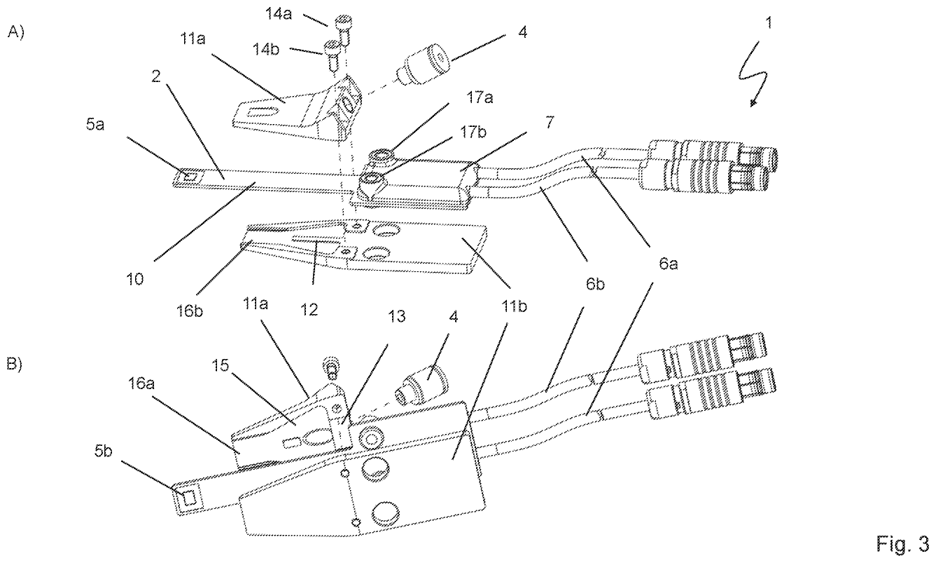

FIG. 3 shows two exploded representations of the gap sensor 1 of FIG. 1, on the one hand from above (A) and on the other hand obliquely from below (B). The gap sensor 1 comprises two sensor elements 5a, 5b, which are arranged on the planar region 2 of a planar carrier or substrate 10. In the connector region 7, the sensor elements 5a, 5b are contacted with the triaxial cables 6a, 6b. The blow off device 3 comprises two half-shells 11a, 11b, which together form a guide element for a gaseous medium—in this case air. The upper half-shell 11a contains the compressed-air connector 4 for the compressed-air hose—not shown—and conveys compressed air from above along the carrier or substrate 10 in the direction of the upper sensor element 5a. The lower half-shell 11b supports the carrier or substrate 10 and conveys compressed air from below along the carrier or substrate 10 in the direction of the lower sensor element 5b. In addition, the lower half-shell 11b also contains a strip 12 that additionally supports the substrate 10. The strip 12 is arranged to an air entry nozzle 13, which serves as an inlet, in the upper half-shell 11a and prevents the substrate 10 from being made to oscillate by the impact of the compressed air. The two half-shells 11a, 11b of the blow off device 3 are connected to one another by screws 14a, 14b and are fixed to the carrier or substrate 10 by a clamping action.

The two half-shells 11a, 11b form a cavity 15, which is in fluid communication with the air entry nozzle 13 and has a side that is open in the direction of the sensor element 5a, 5b so that an air exit nozzle 16a, 16b serving as an outlet is respectively formed. The air entry nozzle 13 forms the inlet for the cavity 15, which serves as a reception or distribution chamber for the air. Via the air exit nozzles 16a, 16b, the compressed air is guided along the substrate 10 in the direction of the sensor elements 5a, 5b so that fouling is effectively removed. In the connector region 7, the substrate 10 contains two threaded bushes 17a, 17b with which the gap sensor 1 can be fastened to an object (not shown here). Alternatively, the fastening may also take place via the blow off device 3, for example by threaded lugs or bushes being formed there.

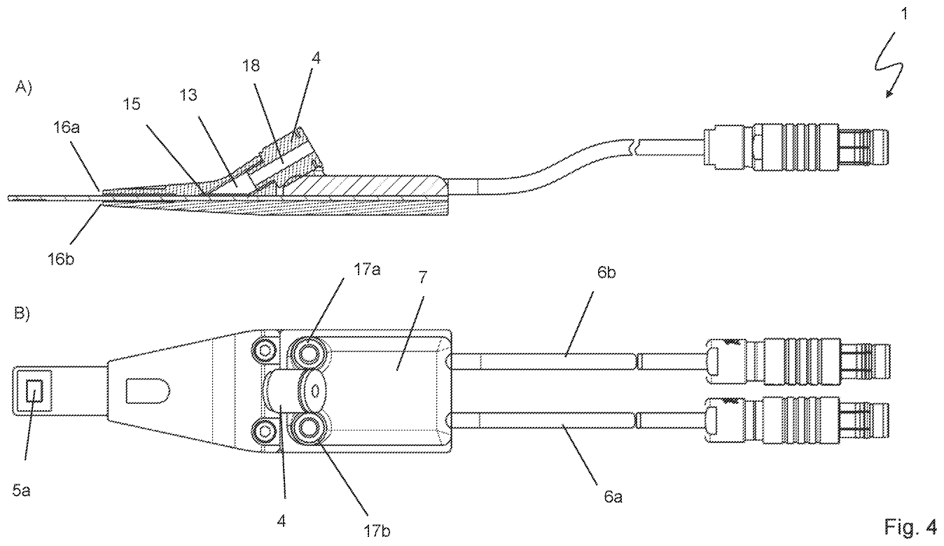

FIG. 4 shows a partially sectional side view (A) and a plan view (B) of the gap sensor 1 according to the first exemplary embodiment of FIG. 1. Via an air channel 18 in the compressed-air connector 4, which can preferably be coupled and uncoupled, compressed air is guided through the air entry nozzle 13 into the cavity 15 and then forwarded to the air exit nozzles 16a, 16b.

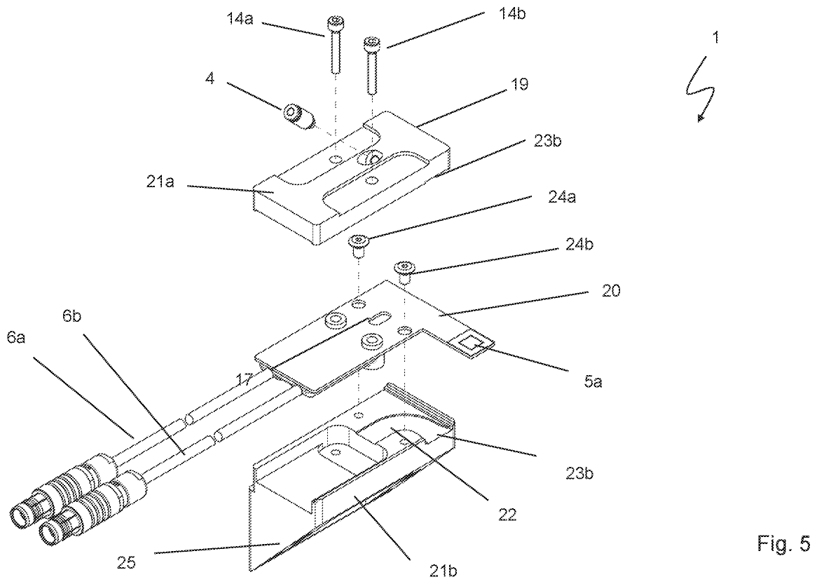

FIG. 5 shows an exploded representation, obliquely from above, of a second exemplary embodiment of the sensor according to the invention, in the form of a gap sensor 1 comprising a blow off device 19 in an angled embodiment. The carrier or substrate 20 is shaped with an angle, ideally with an angle of 90°. The gap sensor 1 can therefore be arranged so that the sensor elements 5a, 5b protrude into a roll gap (not shown here) and the connectors-electrical cables 6a, 6b, compressed-air connector 4-are fed out laterally. This avoids interfering with the rolling process. In this example, the half-shells 21a, 21b are configured so that the cavity 22 is likewise angled and the air exit nozzles 23a, 23b again guide the compressed air in the direction of the sensor elements 5a, 5b. The half-shells 21a, 21b are connected to one another by screws 14a, 14b. In addition, the substrate 20 is also connected to the lower half-shell 21b by press-in sockets 24a, 24b in order to mechanically fix it. In the example, the lower half-shell 21b is at the same time configured for fastening the sensor 1. For this purpose, a metal bracket 25 with which the sensor 1 can be laterally fastened, for example to a roll stand (not shown here), is formed on the half-shell 21b.

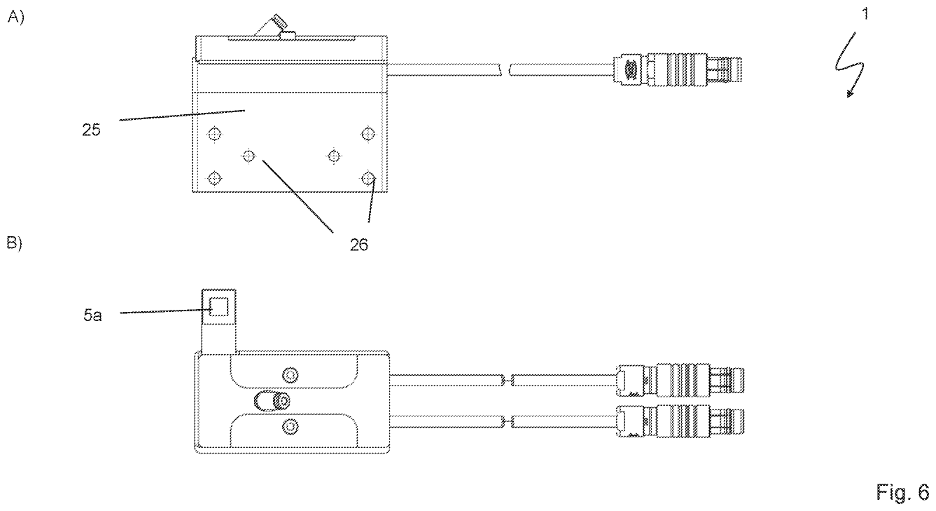

FIG. 6 shows a side view (A) and a plan view (B) of the gap sensor 1 according to the second exemplary embodiment of FIG. 5. Apertures or bores 26 for fastening to an object (not shown here) are applied to the metal bracket 25.

The sensor according to the invention therefore provides a sensor which allows a reliable measurement response with simply designed means under a very wide variety of ambient conditions.

With a view to particularly gentle elimination of fouling or particles on the planar region or sensor element, the device may be configured to generate a laminar flow of the medium along the planar region or sensor element. Such a laminar flow is distinguished by its consistent flow rate, which does not exert any abrupt impulses on a sensor element or a planar region, as may be the case for example with turbulent air vortices. Furthermore, a laminar flow inherently prevents adhesion of fouling and particles on the planar region or sensor element. Fouling and particles comprise inter alia dust and liquids such as water and oils. In any event, a steady flow is advantageous in order not to generate any transverse forces or bending moments on the planar region or the sensor element, which may in turn lead to vibrations of a thin carrier or sensor element. Furthermore, the trajectory of fouling and particles can be controlled well by a laminar flow.

In order to ensure particularly effective elimination of particles or other fouling, the device may have an adjustment mechanism or regulating mechanism for adjusting or regulating the flow and/or a flow rate of the medium. A constant flow with a constant flow rate may in this case be adjusted and/or be regulated, for example by using suitable measurement sensors. Furthermore, if fouling is already present, the adjustment device may generate a pressure surge or a pulsed flow in order to remove fouling that may for example result from failure of the supply of the medium or compressed air, which may lead to accumulations that can remain adhering more or less strongly on a planar region or a sensor element depending on the material, in the event of a sudden high occurrence of fouling or during prolonged stagnation. Flow may in this case take place initially with a relatively high pressure or relatively high Reynolds number, and a pressure may subsequently be reduced, preferably as far as a desired flow or flow rate.

In one specific exemplary embodiment, the flow of the medium may be guided transversely with respect to a measurement direction. This ensures that fouling or particles are purposely moved out from a measurement line predefined by the measurement direction. Alternatively or in addition thereto, the flow of the medium may be guided parallel to the planar region or sensor element. This ensures reliable guiding of fouling or particles away from the planar region or sensor element, without for example bending moments by which a measurement would be vitiated, or rendered impossible, being exerted on the planar region or the sensor element.

In respect of particularly reliable operation of the sensor, the device may comprise a guide element for the flow of the medium, which is allocated to the carrier, the planar region or the sensor element and/or can be coupled to the carrier, to the planar region or to the sensor element and can be uncoupled from the carrier, the planar region or the sensor element. Such a guide element allows a particularly reliable guiding of a flow of the gaseous medium. Depending on the configuration of the guide element, the medium may be conveyed by the guide element in different desired directions in order to eliminate fouling or particles on the planar region or sensor element. By the possibility of coupling and uncoupling, the sensor may also be operated without such a guide element according to requirements. This offers high flexibility in respect of the use of a sensor, on the one hand with and on the other hand without a guide element. It is also thereby possible to retrofit a sensor with a guide element.

With a view to particularly reliable generation of the flow and therefore reliable operation of the sensor, the guide element may comprise a connector for a supply line for the medium. The medium is in this case guided in a straightforward and reliably controllable way through or by the guide element to the planar region or sensor element.

Furthermore, in respect of particularly reliably controlled generation of the flow, the guide element may comprise a reception or distribution chamber for the medium, which is in fluid communication with the connector. Such a reception or distribution chamber may serve as a buffer chamber for the medium and convey received medium in a controlled way to the planar region or sensor element.

For reliable guiding of the flow to the planar region or sensor element, the reception or distribution chamber may comprise at least one outlet for the medium. When one outlet is formed, all of the medium received in the reception or distribution chamber may purposely be conveyed along the planar region or sensor element. When two or more outlets are formed, a plurality of planar regions or sensor elements of the sensor may be supplied with the medium in order to allow the medium received in the reception or distribution chamber to flow along a plurality of planar regions or sensor elements. In the case of a gap sensor comprising two sensor elements, which measure in opposite directions, the medium may be conveyed simultaneously along both sensor elements or along the two associated planar regions in order to achieve the elimination of fouling or particles. By the parallel flows thereby generated, the sensor elements are so to speak sandwiched by the two flows so that the generation of bending moments on the sensor elements, which are detrimental to a measurement, is particularly reliably avoided.

According to requirements and depending on the configuration of the planar region or sensor element, the at least one outlet may comprise a slit, a slit with at least one guide strip or a plurality of apertures arranged next to one another. When a slit is formed—with or without a guide strip—a wide, thin and flat flow may be produced. A flat flow may also be produced reliably by a plurality of apertures arranged next to one another.

The guide element may be formed either in one piece or in multiple pieces. If it is formed in multiple pieces, the guide element may be adapted individually to different measurement conditions, for example of a geometrical nature. Forming it in multiple pieces also allows straightforward replacement of damaged parts while reusing undamaged parts.

In a further exemplary embodiment, the guide element may comprise two couplable or screwable half-shells or be constructed from two couplable or screwable half-shells. Such half-shells may for example be allocated to a carrier or sensor from different sides and very straightforwardly.

The carrier may in this case be arranged securely at least in regions between the half-shells and/or the half-shells may be fixed to the carrier by a clamping action, which provides an arrangement of the carrier that is protected particularly well by means of the half-shells as well as particularly reliable and stable coupling of the carrier and the half-shells or guide element.

Depending on the desired flow direction, the carrier and/or the guide element and/or the reception or distribution chamber may have a curved or angled shape. For example, the curved or angled shape may have a curvature or angles of about 90° in order to deflect the flow correspondingly by about 90° from a supply direction.

In one specific embodiment, the carrier or planar region may comprise two sensor elements, which measure in opposite directions, so as to form a gap sensor with which gap widths can be measured particularly straightforwardly. Very generally, the carrier or flat region may comprise a plurality of sensor elements which measure in different directions, in which case the number of sensor elements and directions may also be three or more, depending on the application.

With a view to a particularly straightforward and reliable design, the carrier may be configured as a printed circuit board or comprise a printed circuit board. The use of printed circuit boards as carriers has proven useful in practice, and allows flexible and economical production of the sensor.

With a view to particularly reliable driving and/or transmission of measurement data to evaluation electronics, the sensor element may be contacted with the evaluation electronics via a coaxial or triaxial cable. A particularly high shielding effect may be achieved by means of a triaxial cable.

Further advantages and aspects of exemplary embodiments of the sensor according to the invention are explained below:

By a permanently attached or retrospectively mountable guide element for the medium, it is possible to integrate a flow or air flow transversely with respect to the measurement direction, which blows away fouling or particles. The two half-shells described above may be configured so that an air flow is formed parallel to the sensor surface or the sensor element.

The flow may be produced over the entire sensor face or the entire sensor element, or entirely over the plurality of sensor elements, optionally on both sides of the carrier.

By a lateral connecting channel in the guide element, it is possible to produce an air chamber or reception or distribution chamber which is fed at one point-one connector-but allows outward flow at different openings or outlets. The direction from which the air or the medium is fed in is unimportant, and may be adapted individually according to the installation situation. For example, compressed air may be fed in through a connector.

This air guide, or this guide element, may be manufactured according to requirements from simple 3D-printed plastic parts up to more complex milled metal parts. The guide or the guide elements and the air chamber or the reception or distribution chamber may be formed as one unit.

In any event, a straightforward configuration of the air exit or of the outlet may be produced at the locations respectively required. In one simple case, the air exit or the outlet may comprise a slit nozzle with strips or without a strip in the gap for guiding the air-preferably in a laminar fashion.

The air exits or the outlets on both sides of the gap sensor have the advantage that the air flow or the flow of the medium does not cause a temperature change on one side and lead to a thin/flexible sensor being bent in one direction. This is because air or a medium is conveyed on both sides from the common air chamber or reception or distribution chamber. Even though deliberate cooling of the sensor does often take place by a temperature difference between the air or the medium and the sensor, this effect is the same on both sides and the sensor lying in the middle remains straight.

In particular, a slender configuration of the sensor in combination with a single connector or air connector allows a very compact sensor which may be employed very well even in narrow installation situations. The guide element may in this case be screwed over the sensor, which may still be mounted at its screwing points intended therefor.

The guide element may be adapted to a roll geometry and ensure additional mechanical stabilization of a thin sensor, for example having a thickness of 0.4 mm. This also reduces the tendency of the sensor to oscillate or vibrate, for example due to external vibrations. The guide element may have a curved surface.

Exemplary embodiments of the sensor according to invention may be used not only for measuring a roll gap, but also generally for gap measurements in a harsh environment where fouling may take place. In respect of further advantageous configurations of the sensor according to the invention, reference is made to the general part of the description and the appended claims in order to avoid additional repetitions.

Lastly, it should expressly be pointed out that the exemplary embodiments described above merely serve to discuss the claimed teaching but do not restrict it to the exemplary embodiments.

1. A sensor for measuring a distance or a position, the sensor comprising:
a carrier (10; 20), which has a planar region (2), and
a sensor element (5a, 5b), which is arranged on the planar region (2) or integrated into the planar region (2),
wherein a device (3) for creating a flow of a gaseous medium along the planar region (2) or sensor element (5a, 5b) is allocated to the carrier (10; 20), the planar region (2) or the sensor element (5a, 5b).

2. The sensor as claimed in claim 1, wherein the device (3) is configured to generate a laminar flow of the medium along the planar region (2) or sensor element (5a, 5b).

3. The sensor as claimed in claim 1, wherein that the device (3) has an adjustment mechanism or regulating mechanism for adjusting or regulating the flow and/or a flow rate of the medium.

4. The sensor as claimed in claim 1, wherein the flow of the medium is guided transversely with respect to a measurement direction and/or parallel to the planar region (2) or sensor element (5a, 5b).

5. The sensor as claimed in claim 1, wherein the device (3) comprises a guide element for the flow of the medium, which is allocated to the carrier (10; 20), the planar region (2) or the sensor element (5a, 5b) and/or can be coupled to the carrier (10; 20), to planar region (2) or to the sensor element (5a, 5b) and can be uncoupled from the carrier (10; 20), the planar region or the sensor element (5a, 5b).

6. The sensor as claimed in claim 5, wherein the guide element comprises a connector (4) for a supply line for the medium.

7. The sensor as claimed in claim 5, wherein the guide element comprises a reception or distribution chamber (15; 22) for the medium, which is in fluid communication with the connector (4).

8. The sensor as claimed in claim 7, wherein the reception or distribution chamber (15; 22) comprises at least one outlet (16a, 16b; 23a, 23b) for the medium.

9. The sensor as claimed in claim 8, wherein the at least one outlet (16a, 16b; 23a, 23b) comprises a slit, a slit with at least one guide strip (12) or a plurality of apertures arranged next to one another.

10. The sensor as claimed in claim 5, wherein the guide element is formed in multiple pieces.

11. The sensor as claimed in claim 5, wherein the guide element comprises two couplable or screwable half-shells (11a, 11b; 21a, 21b) or is constructed from two couplable or screwable half-shells (11a, 11b; 21a, 21b).

12. The sensor as claimed in claim 11, wherein the carrier (10; 20) is arranged at least in regions between the half-shells (11a, 11b; 21a, 21b) and/or the half-shells (11a, 11b; 21a, 21b) are fixed to the carrier (10; 20) by a clamping action.

13. The sensor as claimed in claim 1, wherein the carrier (20) and/or the guide element and/or the reception or distribution chamber (22) has or have a curved or angled shape.

14. The sensor as claimed in claim 1, wherein the carrier (10; 20) or planar region (2) comprises two sensor elements (5a, 5b), which measure in opposite directions, so as to form a gap sensor (1).

15. The sensor as claimed in claim 1, wherein the sensor operates capacitively or inductively or on the basis of an eddy current.
